(19) United States
(12) Patent Application Publication
(10) Pub. No.: US 2012/0315880 A1
(43) Pub. Date: Dec. 13, 2012

(54) DYNAMIC CONTEXT-BASED AUTO-RESPONSE GENERATION

(75) Inventors: Craig A. Peitrow, Saratoga, CA (US); Carlos M. Salinas, Santa Clara, CA (US)

(73) Assignee: APPLE INC., Cupertino, CA (US)

(21) Appl. No.: 13/529,938

(22) Filed: Jun. 21, 2012

Related U.S. Application Data
(63) Continuation of application No. 12/613,646, filed on Nov. 6, 2009.

(51) Int. Cl. H04W 4/12

(52) U.S. Cl. 455/412.1

(57) ABSTRACT

A portable communication device holds an incoming call for a user when the user is temporarily unavailable to pick up the call. In response to an incoming call signal and an indication to hold the call, the portable communication device can answer the call and play back a pre-recorded message to the caller while holding the call. In some embodiments, the portable communication device can determine a set of attributes, e.g., based on the user, the phone, and/or the caller and automatically select a pre-recorded message from several based at least in part on the determined set of attributes. The phone can then answer the call and play the automatically selected pre-recorded message to the caller. Enabling automatic context-sensitive selection of a pre-recorded message by the portable communication device facilitates convenient while accurate user interaction with the caller.

### CROSS-REFERENCES TO RELATED APPLICATIONS

The present application is a continuation application of U.S. application Ser. No. 12/613,646, filed Nov. 6, 2009, now U.S. Publication No. 2011/0111735, published May 12, 2011, the entire contents of which are incorporated herein by reference for all purposes.

### BACKGROUND

An embodiment of the invention relates to a phone hold mechanism of a portable communication device such as a mobile phone.

An incoming call to a mobile phone may sometimes arrive at an inconvenient time. For example, a user of a mobile phone may receive a call during a meeting. The user may prefer to pick up the call only when he is able to extricate himself from the meeting. However, if the user does not pick up the call within a pre-set time period (e.g., with a set number of ring tones or vibration cycles), the call is automatically re-directed to voicemail.

Consider the following scenario, which is quite typical in daily mobile phone usage. A user is alerted that an incoming call has arrived when he is temporarily unable to answer the call. The call is re-directed to voicemail before the user can pick up the phone. The user tries to call back the caller, while the caller is leaving a message on the voicemail, and is therefore re-directed to the caller's voicemail. As a result, the two are talking to each other's voicemail even though they are available and intend to talk to each other live.

Sometimes, the caller may not want to leave a message and simply hangs up after being re-directed to voicemail. The caller may then be temporarily unavailable when the user, who has seen the missed call on her mobile phone, returns the call. Thus, there may be a long delay before the user can finally get in touch with the caller. It can be frustrating to the user of the mobile phone that his temporary inability to pick up the initial incoming call would cause so much inconvenience. This could be useful in a situation where both answering a call and listening to a resulting voicemail may both be disturbing to the user's current environment.

### SUMMARY

An embodiment of the invention is directed to a portable communication device, which, in response to an incoming call signal and an indication from the user to hold the call, answers the call and plays back a pre-recorded message to the caller while holding the call. The call can be held until the user picks up the call. The pre-recorded message can be selected by the user from a list of options presented to the user after the incoming call arrives, or pre-selected by the user before the incoming call arrives.

In another embodiment, the user of the portable communication device is on another call when the incoming call arrives. The portable communication device answers the incoming call with a pre-recorded message and holds the incoming call, and concurrently maintains uninterrupted communication on the in-progress call.

In yet another embodiment, the pre-recorded message includes a request for the caller to speak. A speech-to-text converter in the portable communication device then converts the caller's speech to text, and the text is displayed on a display screen of the portable communication device. Thus, the user does not need to speak into the phone, and is able to read the message from the caller.

In another embodiment, the user can enter an estimated hold time for the call being held. An adjustable hold time indicator can be shown on the display screen. The user can adjust the hold time by sliding his finger on a touch panel or on a touch screen where the indicator is displayed, tapping on the indicator, dragging an adjustment tab on the indicator, or entering physical keystrokes. The estimated hold time can be announced to the caller.

Another embodiment of the invention is directed to a portable communication device, which, in response to an incoming call signal and an indication from the user to hold the call, automatically determines a pre-recorded message to be played back to the caller when the call is on hold, answers the call and plays back the pre-recorded message to the caller while holding the call. The call can be held until the user picks up the call. The portable communication device in some embodiments can automatically determine the pre-recorded message to be played back to the caller by determining a set of attributes of the user, the portable communication device, the caller, etc. Based upon the set of attributes, the portable communication device can select the pre-recorded message from a list of pre-recorded messages and play the selected message back to the caller while the call is on hold.

In some embodiments, upon receiving an incoming call signal, the portable communication device can automatically determine whether to hold the call based on a set of user circumstances. The set of user circumstances can indicate a location or a status of the user.

In response to determining the set of user circumstances, the portable communication device can determine to hold the call if the set of user circumstances indicates that the user would likely indicate to the portable communication device to hold the call but for the user being currently preoccupied and unable to indicate to the portable communication device to hold the call.

In some embodiments, the portable communication device can consider user input when determining the pre-recorded message to be played back to the caller when the call is on hold. Instead of selecting the pre-recorded message to be played back to the caller, the user can input information that enables the portable communication device to determine the pre-recorded message to be played back to the caller more accurately. The user input can include an indication of the user's current setting, the user's current situation, etc. In some embodiments, the portable communication device can use the user input, in addition to the set of attributes determined by the portable communication device, to determine the pre-recorded message from the list of pre-recorded message to play back to the caller while the call is on hold.

In some embodiments, the portable communication device can present a customized list of pre-recorded messages to the user in response to an incoming call signal and an indication from the user to hold the call. The portable communication device in some embodiments can determine a customized list of pre-recorded messages to present to the user by determining a set of attributes. The set of attributes can include attributes of the user, the portable communication device, the caller, etc. Based on the set of attributes, the portable communication device can determine a list that includes pre-recorded messages that are likely to be appropriate. In response to receiving a user selection of a pre-recorded message from the customized list, the portable communication device in some embodiments can answer the call and play back the selected pre-recorded message to the caller while holding the call. The call can be held until the user picks up the call.

The portable communication device may be configured or programmed by its user, to support one or more of the above-described portable communication device hold features.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 is a diagram of a portable communication device (also referred to as a receiving phone) operating to receive an incoming phone call.

FIG. 2 is a block diagram illustrating an embodiment of the components of the receiving phone.

FIG. 3 is a timeline of events that occur while processing an incoming phone call at the receiving phone.

FIGS. 4A-4C show an example of a receiving phone that provides a sequence of options for a user to place an incoming call on hold.

FIGS. 5A-5B show an example of a receiving phone that places an incoming phone call on hold while communicating on another call.

FIG. 6 shows an example of a receiving phone communicating with a caller of a held call using text messages.

FIG. 7 is a flow diagram of a process for responding to a communication request from a sender and presenting the sender with an automatically selected pre-composed message according to an embodiment of the present invention.

FIG. 8 illustrates an example timeline for operating a portable communication device and automatically selecting a pre-recorded message in accordance with some embodiments.

FIG. 9 is a flow diagram of a process for automatically selecting a pre-composed message after not receiving a user indication a certain time period after receiving a communication request according to an embodiment of the present invention.

FIG. 10 illustrates an example timeline for operating a portable communication device and automatically selecting a pre-recorded message in response to not receiving any user input, within a time interval from receiving a communication request from a caller in accordance with some embodiments.

FIG. 11 is a flow diagram of a process for allowing a portable communication device to take user input into account in determining the pre-recorded message to present to the caller in accordance with some embodiments.

FIG. 12 illustrates an example timeline for operating a portable communication device for selecting a pre-recorded message by considering a set of attributes in addition to user input in accordance with some embodiments.

FIGS. 13A-13C illustrate an example sequence of screen images for a portable communication device that automatically determines a pre-recorded message in accordance with some embodiments

### DETAILED DESCRIPTION

Certain embodiments of the invention relate to automatically determining a pre-composed message to be presented to a sender of a communication request when a user (the intended recipient of the request) is currently unavailable for communication with the sender (e.g., in the middle of a meeting, in the middle of a workout, driving, etc.). In some embodiments, an electronic device of the user can determine a pre-composed message based on a set of attributes including attributes of the user, the electronic device, and/or the sender. Using the set of attributes, the electronic device can automatically determine and send an appropriate context-based pre-composed message to the sender to convey information (e.g., the user is in a meeting, the user is in the middle of a workout, the user is driving, etc.) to the sender that the user otherwise would not have been able to.

In some embodiments, the communication medium is session-based, and the pre-composed message can be sent to the sender only after a communication session has been established between the sender and the user. Two or more electronic devices can establish a communication session through a session-based communication medium, such as a telephone network, an instant messaging (IM) service, a voice over internet protocol (VoIP) service, a video chat service, etc. In a session-based communication, two parties can establish a communication session when they are connected or “logged-into” the same communication medium or service. For instance, a communication session can be established when a user picks up a phone call from a caller where the parties are connected through the phone line (e.g., a physical circuit or wireless channel connecting two phones may be established when a caller dials and a recipient picks up the phone). In another instance, a communication session can be established when a user accepts an instant messaging request from a sender through an IM service where the parties are online and logged into the same service.

After the communication session is established, the pre-composed message can be sent to the sender while the communication is on hold. For instance, the recipient of a phone call can become connected with the caller through a telephone network and send the pre-composed message after placing the communication on hold. By holding the communication, the caller can stay connected (stay on the line) with the recipient until the recipient becomes available to pick up the call (instead of having to re-direct the unanswered call to voicemail). The caller can determine whether to stay on the line after receiving the pre-composed message from the recipient.

While some communication media are session-based, some communication media are sessionless (e.g., e-mail, text messaging, short messaging service (SMS)). Through sessionless communication media, a sender can send a message that can be stored at a location until the user chooses to look at, listen to, or retrieve the message. The user can respond to the message at a time that is convenient for her, regardless of whether the parties are connected or whether the other party is “logged-into the same service.” For a sessionless communication, the user can indicate to hold the communication (e.g., by sending a “hold” message) at any time without having to establish a communication session. The electronic device can send the pre-composed message to the sender after the user has indicated to hold the communication in some embodiments.

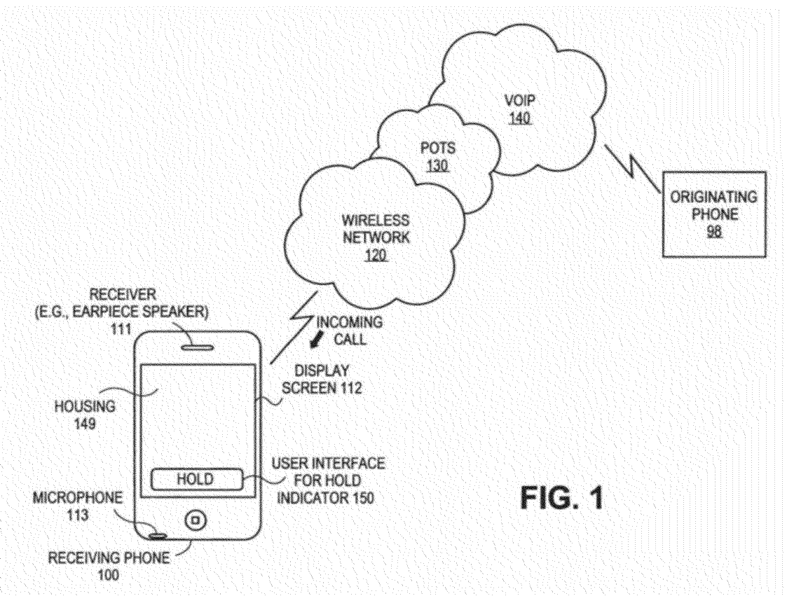

In some embodiments, an electronic device can send a pre-composed message (e.g., pre-recorded message using the recipient's own voice) to a sender of a communication request (e.g., a caller) upon receiving an indication from a recipient. FIG. 1 is a diagram illustrating a communication environment in which a receiving phone 100 receives a phone call from an originating phone 98 over a communication network. The term “phone” herein broadly refers to various two-way, real-time communication devices, e.g., landline plain-old-telephone system (POTS) end stations, VoIP end stations, cellular handsets, smart phones, etc. In some embodiments, the receiving phone 100 can be a portable communication device that provides two-way, real-time mobile telephonic connections. For example, the receiving phone 100 can be a mobile phone or a mobile multi-functional device that can send and receive voice signals in a cellular communication network.

The receiving phone 100 communicates with the originating phone 98 over a communication network, for example, a wireless network 120, POTS 130, and a VoIP network 140. Communications between the receiving phone 100 and the wireless network 120 may be in accordance with known cellular telephone communication network protocols including, for example, global system for mobile communications (GSM), enhanced data rate for GSM evolution (EDGE), and worldwide interoperability for microwave access (WiMAX). The receiving phone 100 may also have a subscriber identity module (SIM) card, which is a detachable smart card that contains the subscription information of its user, and may also contain a contacts list of the user. The user or caller may own the receiving phone 100 or may otherwise be its primary user. The receiving phone 100 may be assigned a unique address by a wireless telephony network operator, such as an eleven digit international telephone number or an Internet Protocol (IP) address.

The exterior of the receiving phone 100 is made of a housing 149 within which are integrated several components including a display screen 112, a receiver 111 (e.g., an earpiece speaker for generating sound) and a microphone 113 (e.g., a mouthpiece for picking up sound). The receiving phone 100 also includes a user input interface for receiving user input. In one embodiment, the user input interface includes a “hold” indicator 150, which may be a physical button or a virtual button. The physical button may be a dedicated “hold” button, or one or more buttons identified by the text shown on the display screen 112 (e.g., “press ## to hold this call”). In an embodiment where the “hold” indicator 150 is a virtual button, the virtual button may be implemented on a touch-sensing panel that includes sensors to detect a user's touch and motion. The sensors may be based on resistive sensing, capacitive sensing, optical sensing, force sensing, surface acoustic wave sensing, and/or other sensing techniques. The coordinates of the sensors that respond to the user's touch and motion represent a specific user input. In one embodiment, the touch-sensing panel can be embedded within the display screen 112. When an incoming call arrives, the display screen 112 shows a graphical “hold” button that can be pressed by the user to hold the incoming call. In an alternative embodiment, the touch-sensing panel can be separate from the display screen 112, and can be used by the user to direct a cursor on the display screen 112 to select a graphical “hold” button shown on the display screen 112.

Turning to the originating phone 98, the originating phone 98 from which an incoming call originates need not be a mobile device, but instead may be a land-based device that is coupled to a telephony network through wires or cables. The originating phone 98 may be identified with a unique address, such as a telephone number within the public switched telephone network. The originating phone 98 may also have an Internet protocol (IP) address if it performs calls through a VoIP protocol. The originating phone 98 may be a cellular handset, a plain old telephone service (POTS), analog telephone, a VoIP telephone station, or a desktop or notebook computer running telephony software.

In addition to establishing communication between the caller and receiver through a phone call, it is appreciated that communication between two users can be established through various other communication methods, such as through instant messaging services or short messaging services. In some embodiments, the receiving phone 100 and/or the originating phone 98 can be an electronic device such as a personal computer, laptop computer, television set top box, cellular phone, PDA, electronic book reading device, video game system, or portable media player, among others. A communication between two users can be established through establishing a connection (e.g., over the communication network) between the two electronic devices.

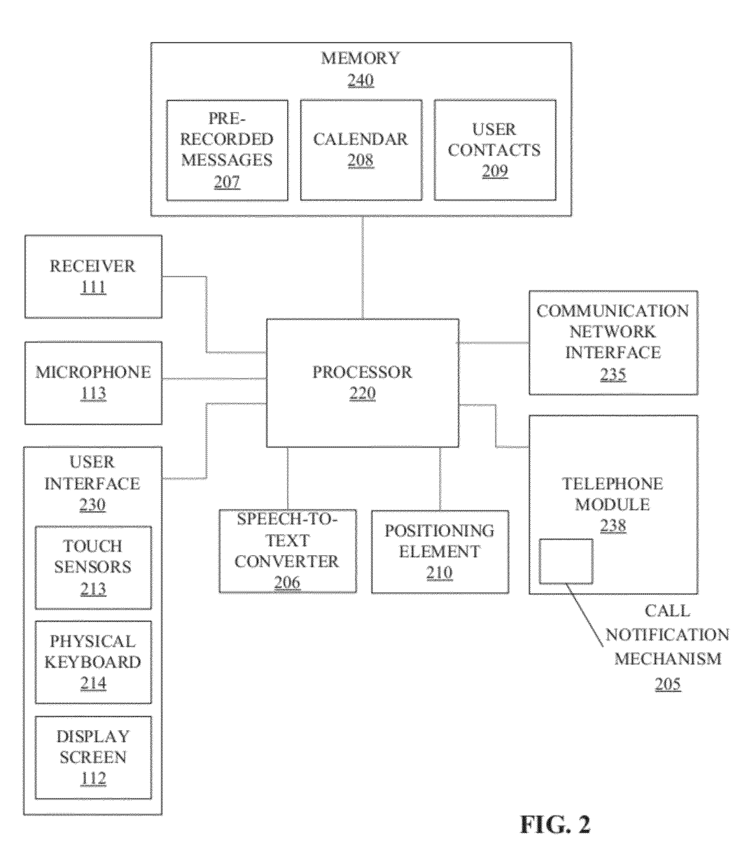

FIG. 2 is a block diagram illustrating an embodiment of the receiving phone 100. The receiving phone 100 includes a communication network interface 235 for receiving and transmitting communication signals, e.g., audio, video and/or data signals. The communication network interface 235, in one example, includes a transceiver capable of supporting any type of communication technology, including Internet telephony, cell phones, landlines, etc. The receiving phone 100 also includes the receiver 111 for generating audio signals in response to an incoming call signal, the microphone 113 for picking up audio signals from the user, and a user interface 230 that includes the display screen 112 and touch sensors 213 for sensing user's touch and motion. In some embodiments, the receiving phone 100 also includes a physical keyboard 214 for receiving keystrokes input from the user. In alternative embodiments, the receiving phone 100 may include a virtual keyboard implemented by the touch sensors 213. The touch sensors 213 may be embedded in the display screen 112, or may be separate from the display screen 112. The receiving phone 100 also includes a positioning element 210 for determining a location, orientation, position (e.g., using a global positioning system (GPS)) of phone 100. Additional circuitry, including a combination of hardware circuitry and software, can be included to obtain the needed functionality described below. These are not described in detail as they would be readily apparent to those of ordinary skill in the art of mobile phone circuits and software.

In one embodiment, the receiving phone 100 also includes a telephone module 238 which is responsible for coordinating various tasks involved in a phone call. The telephone module 238 may be implemented with hardware circuitry, or may be implemented with one or more pieces of software or firmware that are stored within memory 240 in the receiving phone 100 and executed by a processor 220. Although one processor 220 is shown, it is understood that any numbers of processors may be included in the receiving phone 100. The telephone module 238 coordinates tasks such as receiving an incoming call signal, directing the call signal to a call notification mechanism 205 to alert the user of the incoming call, answering the call for the user, playing back pre-recorded messages 207 in the memory 240 and holding the call. In some embodiments, telephone module 238 further coordinates tasks such as accessing calendar information 208 of the user in the memory 240 to determine user attributes for selecting or constructing a pre-recorded message, accessing user contact information 209 (e.g., an address book) of the user in the memory 240 to determine attributes of a caller for selecting a pre-recorded message. Further, telephone module 238 can retrieve location information using positioning element 210 as a device attribute for selecting a pre-recorded message. After the call is picked up by the user, the telephone module 238 can direct audio signals (between the microphone 113 and the caller, and between the caller and the receiver 111 or a speakerphone), and end the call.

In one embodiment, the call notification mechanism 205 includes an actuator that vibrates the housing 149 (FIG. 1) of the receiving phone 100 to alert the user of an incoming call. The call notification mechanism 205 can also cause the processor 220 to retrieve a stored ring tone in response to an incoming call signal, which triggers a ringer of the receiving phone 100 to generate ring tones. Alternatively or additionally, the call notification mechanism 205 can cause, in response to an incoming call signal, the display screen 112 and/or other visual indicators to flash.

Still referring to FIG. 2, in one embodiment, the receiving phone 100 includes a speech-to-text converter 206 to convert a speech signal into text. The speech-to-text converter 206 may be implemented with hardware circuitry, or may be implemented with software or firmware stored within memory 240 in the receiving phone 100 and executed by the processor 220. The speech-to-text converter 206 identifies the words in an input speech signal based on one or more speech recognition techniques, and causes the display screen 112 to show the recognized words in text. The speech-to-text converter 206 can convert the user's speech into text for transmission to a remote party, and can also convert the speech signal of the remote party into text for display on the display screen 112. The speech-to-text converter 206 may be activated and deactivated by the user by an input to the user interface 230 (e.g., a physical button or a virtual button).

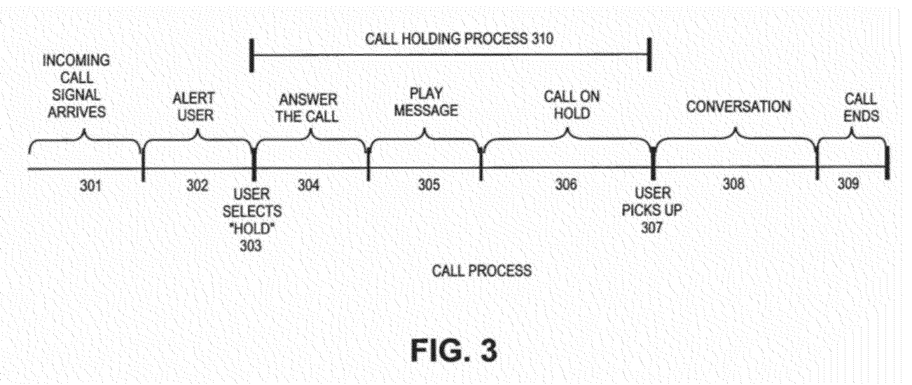

An example timeline for operating the receiving phone 100 for holding a call is shown in FIG. 3. Referring to FIG. 3, operation may begin when the receiving phone 100 receives a signal from a telephony or communication network representing the arrival of an incoming call; that is, a signal which triggers the familiar “ringing” event in the receiving phone 100. This occurred because a called “dialed” the address (generically referred to here as the phone number) assigned to the receiving phone 100. Upon receiving the incoming call signal, the receiving phone 100 alerts the user of the incoming call (302). The alert may be in the form of an actuator vibrating the housing of the receiving phone 100 if the phone has been set to a vibration mode. Alternatively, the alert may be in the form of ring tones, flashing backlight of the display screen 112, or other audio or visual indications. In the meantime or simultaneously, the receiving phone 100 also presents the user with a number of options to respond to the incoming signal: accept (i.e., pick up) the call, hold the call, or re-direct the call to a voicemail (VM) system.

If the user picks up the call, a communication link is established between the user and the caller for the two parties to begin a conversation. If the user selects to re-direct the call to a voicemail system, the incoming call will be picked up by the voicemail system which will then record a message from the caller. The message left by the caller may be stored in the memory 240 of the receiving phone 100, or it may be stored in a remote voicemail server. Typically, once the call is re-directed to the voicemail system, the user cannot stop the call redirection process to pick up the call and speak live with the caller. After the caller finishes leaving the message and hangs up the originating phone, the user may retrieve the message of the caller from the voicemail system and/or return a call to the caller.

If the user selects to hold the call (303), a call holding process (310) starts. In response to the user's indication to hold the call, the receiving phone 100 answers the incoming call (304) and then plays back a pre-recorded message to the caller (305). The pre-recorded message may indicate that the user is temporarily unavailable to answer the call, and ask the caller to stay on the line for a short time. After the pre-recorded message is played, the receiving phone 100 continues to hold the incoming call (306) until the user picks up the call (307). The user can pick up the call by pressing a call pickup button (e.g., a physical button or a virtual button) on the receiving phone 100. Once the user picks up the call, the call holding process 310 ends. The two parties are then “live” and so can start a conversation (308) until one or both of the parties end the call (309). Alternatively, the call holding process 310 may end when one of the two parties decides to no longer stay on hold and terminate the call.

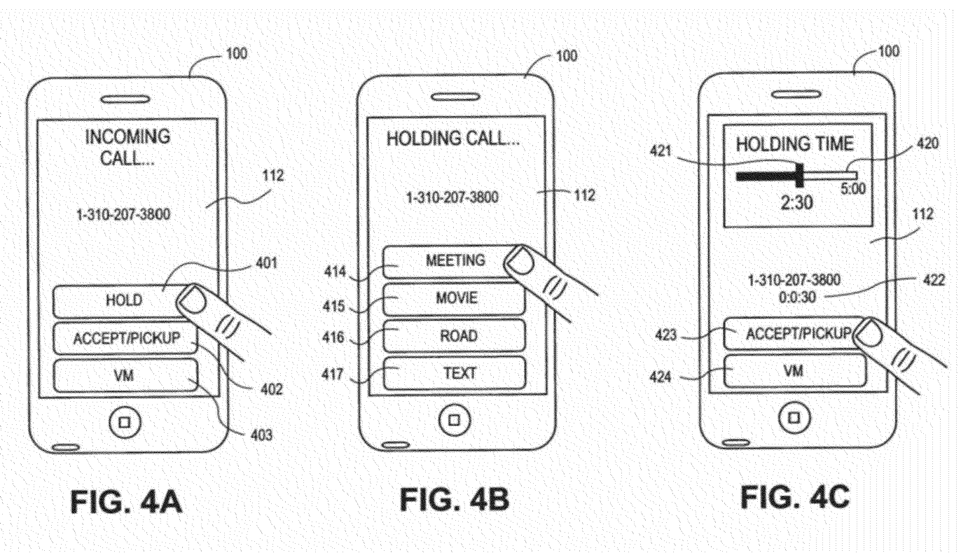

FIGS. 4A-4C show an example of the receiving phone 100 that provides a sequence of options for a user to place an incoming phone call on hold. In one embodiment shown in FIG. 4A, in response to the arrival of an incoming call signal, the receiving phone 100 displays “INCOMING CALL . . . ” on the display screen 112 and the number assigned to the caller of the incoming call. In one embodiment where the receiving call 100 stores a list of contacts including their nicknames and numbers, the display screen 112 may show the nickname of the caller in addition to or instead of the calling number. The display screen 112 may also present a number of options for the user to choose. The options may include: hold 401, accept (i.e., pick up) 402 and voicemail 403. The user may select one of these options using a physical button or a virtual button.

Once the user selects the hold option 401, the display screen 112 may show “HOLDING CALL . . . ” to indicate that the call holding process has started. The display screen 112 can also show the calling number and/or the nickname of the caller. In one embodiment shown in FIG. 4B, the receiving phone 100 may provide the user with a number of additional options, each associated with a different pre-recorded message. For example, an option 414 may correspond to a pre-recorded message indicating that the user is currently in a meeting, but will step out of the meeting shortly to answer the call. Similarly, options 415 and 416 may indicate that the user is in a movie and on the road, respectively, but will come to the phone shortly. An option 417 may correspond to a pre-recorded message indicating that the user cannot talk on the phone at this moment, but is able to read text. Thus, the caller can send a text message to the user, or can have the receiving phone 100 convert his speech into text for the user to read on the display screen 112. Further details regarding the use of the option 417 will be provided in connection with FIG. 6. In the pre-recorded message associated with any of the above-described options 414-417, it may also be indicated to the caller that the caller can opt-out of a hold and jump to voicemail at anytime during the hold. For example, the pre-recorded message can indicate to the caller that the voicemail bailout option can be reached by pressing # at any time during the hold. More or different options may be provided by the receiving phone 100.

In an alternative embodiment, the receiving phone 100 may display the options 414-417 at the same time as the initial hold/pickup/voicemail decision of 401-403. In another embodiment, the receiving phone 100 may be configured to associate a particular default message with a caller based on the phone number or the caller ID of the caller. Thus, when the caller calls the receiving phone 100 and is to be placed on hold, the default message associated with the caller will be played. In yet another embodiment, before the user is engaged in a situation in which he will be temporarily unable to answer a call (e.g., in a meeting), the user may select a pre-recorded message indicating that he is in a meeting. Then once the user selects the hold option 401, a pre-recorded message indicating that the user is in a meeting will be automatically played without the user further selecting the meeting option 414.

Once the user indicates to hold the call, the receiving phone 100 plays back a default or a selected message to the caller while holding the incoming call. The message sent to the caller can incorporate an estimated length of hold time as indicated by the user. Referring to FIG. 4C, the user may enter an estimated hold time with an estimated hold time indicator 420 provided on the display screen 112. For example, the estimated hold time indicator 420 may be a slide bar that can be adjusted by the user to indicate the estimated hold time. The entire length of the slide bar may represent a maximum hold time (e.g., 5 minutes), which can be configured by the user. The slide bar may be adjusted by a configurable increment (e.g., 10 seconds). In the embodiment of FIG. 4C, the user can move an adjustment tab 421 along the slide bar to indicate an estimated hold time in the increment of 10 seconds up to a maximum of 5 minutes. The user may move an adjustment tab 421 by dragging the tab 421, by sliding a finger near the slide bar, by tapping on the surface of the display screen 112 one or more times, or by pressing a key on a physical or virtual keyboard. Each tap or keystroke may represent an increment of the estimated hold time (e.g., 10 seconds). The receiving phone 100 detects the position of the adjustment tab 421, converts the position into a length of time, and incorporates the length of time into the pre-recorded message played to the caller. For example, the user may pre-record a message to say “I am in a meeting right now, but please hold and I will answer your call shortly.” The receiving phone 100 can automatically insert the estimated hold time into the message, e.g., at the end of the message, to say “The estimated hold time is 2 minutes.” The feature of the estimated hold time can be activated and/or deactivated by the user anytime before or during the receipt of an incoming call.

The display screen 112 may show an elapsed time indicator 422 that indicates how long the caller has been placed on hold. At anytime during the hold, the user can pick up the call (with an option 423) or re-direct the call to voicemail (with an option 424). If the option 424 is selected, a special voicemail greeting may be played to the caller to indicate that the user cannot pick up the call within a reasonable amount of wait time as he has previously expected. For example, the special voicemail greeting may indicate: “Sorry for the wait, but I cannot pick up your call at this time. Please leave a message after the tone.”

In one embodiment, the estimated hold time may be updated by the user while the incoming call is placed on hold. For example, after the call is on hold for 30 seconds, the user may realize that more or less hold time is needed. The user can change the hold time by moving the adjustment tab 421 on the slide bar to the right (e.g., more hold time) or to the left (e.g., less hold time). In response to the change of the hold time, the receiving phone 100 automatically announces to the caller the updated hold time estimate.

In some scenarios, the incoming call may arrive when the user is on another line of the receiving phone 100. Conventional phones provide a call waiting feature which allows the user to suspend the call in progress and switch to the incoming call. Instead of or in additional to the call waiting feature, the receiving phone 100 can continue the in-progress phone call without interruption, while holding the incoming call for the user. While holding the incoming call, the receiving phone 100 can play back a pre-recorded message to ask the caller to stay on the line until the user picks up the call.

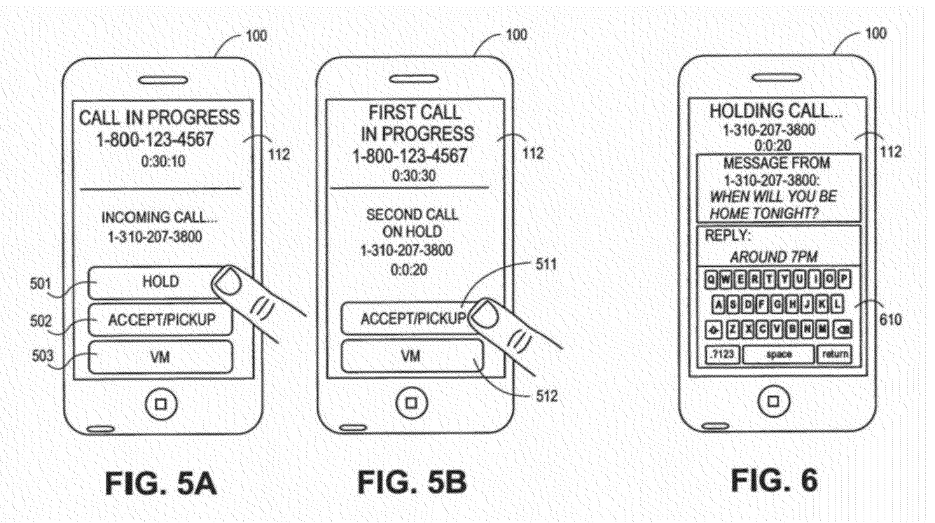

Referring to the example shown in FIG. 5A, the display screen 112 of the receiving phone 100 shows that an incoming call (the second call) arrives while another call (the first call) is in progress. In the example, the top portion of the display screen 112 shows the number (or a corresponding nickname) and the elapsed time (e.g., 30 minutes and 10 seconds) of the first call. The lower portion of the display screen 112 shows the number (or a corresponding nickname) of the incoming call, as well as a number of options (e.g. hold 501, accept/pickup 502, voicemail 503) for the user to handle the call. If the user selects the hold option 501, the receiving phone 100 answers the incoming call and plays a pre-recorded message while holding the incoming call on hold. The in-progress call is not interrupted by the incoming call. The receiving phone 100 may provide additional options, such as those described above in connection with FIGS. 4B and 4C, to the user for holding the phone. For example, the options can include a list of pre-recorded messages for the user to choose, such as those shown in FIG. 4B. The user can also pre-configure the receiving phone 100 to select a default message, or to associate selected contacts with particular default messages. The user can also enter an estimated hold time as shown in FIG. 4C, and the receiving phone 100 can incorporate the estimated hold time into the message played to the caller of the incoming call.

In an alternative scenario, if the user elects to pick up the incoming call, the first call will be placed on hold. The receiving phone 100 can play a pre-recorded message to the caller of the first call while holding the first call. In yet another scenario, if the user elects to re-direct the incoming call to voicemail, the voicemail system of the receiving phone 100 will pick up the incoming call, without interrupting the first call, for the caller of the incoming call to leave a message.

Referring to the example shown in FIG. 5B, after the user elects to hold the incoming call, the display screen 112 continues to show the telephone number of the in-progress call (the first call) and its elapsed time. Concurrently, the display screen 112 also shows the telephone number and the elapsed time of the call on hold (the second call), as well as options for the user to handle the second call. For example, at anytime during the first call is in progress, the user can select an accept/pickup option 511 to pick up the second call and place the first call on hold, or the user can select a voicemail option 512 to re-direct the second call to voicemail. The user can also select the accept/pickup option 511 to pick up the second call after the first call ends. Similar to the scenario described in connection with FIG. 4C, if the user elects to re-direct the second call to voicemail after the call has been placed on hold for a period of time, a special pre-recorded greeting may be played to the caller to apologize for the wait and ask the caller to leave a message.

In one embodiment, the first call and the second call shown in FIGS. 5A-5B can be handled simultaneously. That is, the receiving phone 100 may simultaneously handle two connections: one connection carries an uninterrupted in-progress call (the first call), and another connection carries an incoming call (the second call) to which the user can respond by entering text messages. Thus, the user of the receiving phone 100 can be texting using one connection while talking uninterruptedly using the other connection.

In one embodiment, the receiving phone 100 supports a speech-to-text feature. Referring back to FIG. 4B, after the user is alerted of the arrival of the incoming call, the user may choose to hold the call and select the “text” option 417 to activate the speech-to-text feature. Alternatively, the user may pre-configure the receiving phone 100 to activate the speech-to-text feature before an incoming call arrives. This feature can be useful when the user is unable to listen to the phone but is able to read text on the display screen 112. For example, the user may be in a meeting where he is not supposed to hold the receiving phone 100 to his ear, but he may read a text message without being noticed by other meeting attendees. If the user selects the “text” option 417, the receiving phone 100 will play a pre-recorded message to the caller, indicating that the user is temporarily unavailable to speak to the caller, but is able to send text messages. If the caller is calling from a device that has texting capabilities, the user and the caller can exchange text messages. If the caller is calling from a device (e.g., a plain landline phone) that cannot send and receive text, the caller can speak to the phone, and the receiving phone 100 automatically converts the caller's speech into words and shows the words on the display screen 112. The speech-to-text conversion may be performed by the speech-to-text converter 206 of FIG. 2.

In one embodiment, the receiving phone 100 may provide both text-to-speech conversion and speech-to-text conversion. If the caller is calling from a device (e.g., a plain landline phone) that cannot send and receive text, the receiving phone 100 can automatically convert the caller's speech into text and the automatically convert the user's text reply into speech for transmission to the caller. An example of this scenario is shown in FIG. 6.

Referring to the example shown in FIG. 6, the display screen 112 shows the telephone number of the call on hold and the elapsed time of the call. A panel of the display screen 112 shows a text message converted from the caller's speech, which may be “When will you be home tonight?” In response to the text message, the user can input a reply, e.g., “around 7 PM,” via a physical or a virtual keyboard 610 on a touch sensing panel of the receiving phone 100. The reply can be converted into speech signals and sent via the established communication link between the caller and the user.

In an alternative scenario, the message from the caller may be purely informational and does not request a reply from the user. For example, the caller may simply inform the user that the movie starts at 5 pm. In this alternative scenario, either or both parties to the call can hang up the phone once the text message is received from the caller.

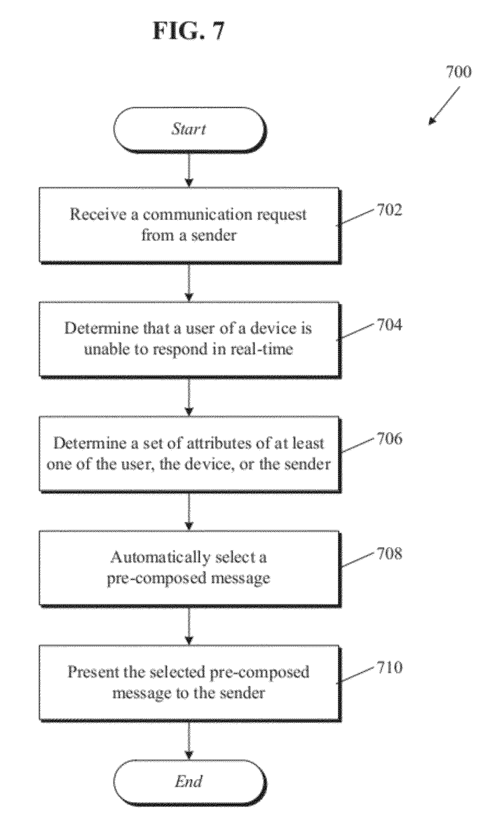

While some embodiments allow the user to select the pre-recorded message that the user would like played to the caller while the call is on hold, the phone (or other electronic communication device) in some embodiments can automatically determine the appropriate pre-composed message to present to the caller (also referred to as a sender). An appropriate pre-composed message is a pre-composed message that the user would likely want played to the sender based on a set of attributes including the user's current situation, the sender's characteristics, characteristics about the user's device, etc. FIG. 7 is a flow diagram of a process 700 for automatically selecting a pre-composed message, by an electronic device of the user (e.g., similar or identical to phone 100 of FIG. 1), and presenting the sender with the selected pre-composed message according to an embodiment of the invention. Process 700 can be implemented, e.g., in phone 100 of FIG. 1.

At block 702, an electronic device can receive a communication request (e.g., a phone call) from a sender (e.g., a caller). In some embodiments, the sender can send a communication request to the user by using another electronic device (e.g., another portable communication device similar to phone 100). It is appreciated that the sender can send communication requests to the user via various communication methods, such as through a telephone network, through text messaging, through emailing, through instant messaging, through video calling etc.

At block 704, the electronic device can determine that the user of the electronic device is unable to answer the communication request in real-time (i.e., with minimal latency or no delay). In some embodiments, the electronic device can determine that the user is unable to respond to the communication request in response to receiving a user indication. For example, the user can select a selectable user interface (UI) item displayed on a display of the electronic device, toggle a switch that is part of the electronic device, perform a hand gesture at the electronic device, or give a voice command to indicate that the user is unable to respond to the communication request at the moment and would like the device to hold the communication.

In some embodiments, the electronic device can automatically determine that the user is unable to answer the communication request by assessing the user's circumstances (e.g., a location or status of the user) upon receiving a communication request. For example, the electronic device can determine that the user is unable to answer the communication request based on the user's current location being in a meeting, in class, in a car, etc. In some embodiments, the electronic device can determine the user's circumstances by retrieving the user's schedule from the user's electronic calendar (e.g., calendar 208 in FIG. 2), by using a GPS receiver (e.g., positioning element 210 in FIG. 2) in or coupled to the electronic device, by detecting the user's surroundings using one or more cameras in or coupled to the electronic device, etc. Upon determining that the user is unable to answer the communication request, the electronic device can hold the communication.

At block 706, the electronic device can determine a set of attributes of at least one of the user, the electronic device of the user, or the sender. For example, the electronic device can determine a set of user attributes including a current state or a characteristic of the user, such as whether the user is asleep, awake, in a meeting, at the gym, etc. In some embodiments, the electronic device can also determine a set of attributes of the electronic device, such as the current location, a current time, a motion of the electronic device, a proximity of the electronic device to one or more other electronic devices, a network connection status of the electronic device, and/or an application currently running on the electronic device.

Some embodiments also allow the electronic device to determine a set of sender attributes (e.g., by accessing contacts information 209 in FIG. 2), such as whether the sender is a family member of the user, a colleague, a classmate, or an unidentified sender. In some embodiments, the electronic device can determine the set of sender attributes by accessing an address book of the user, either stored locally on the electronic device or stored and accessible at a remote server. When the sender is requesting communication with the user, additional information from the sender can be included in the request, such as whether the sender has indicated that the communication is urgent, the number of times that the sender has tried to reach the user, etc.

By obtaining the set of attributes including user attributes, the electronic device attributes, and/or sender attributes, the electronic device can analyze and assess the situation around the communication request in order to more accurately determine the appropriate pre-composed message that the user desires to send to the sender (i.e., the pre-composed message that the user would likely have selected if the user was able to make the selection).

At block 708, the electronic device can automatically select a pre-composed message from several pre-composed messages stored on or accessible to the electronic device to be provided or presented to the sender. In some embodiments, the electronic device selects the pre-composed message based at least in part on the set of attributes determined at block 706. A pre-composed message can include textual data, audio data, video data, still-image data, etc. For example, a pre-composed message can include a textual component and/or an audio of the user's voice, along with a picture of the user presented to the sender.

Based at least in part on the set of attributes, the electronic device can select a pre-composed message to present to the sender. For example, the electronic device can determine that the user is currently in a meeting based on the user's current location being in a conference room, based on the user's network connection with a particular network, and/or based on detection of the user's boss's electronic device within a threshold distance of the electronic device, etc. Upon determining that the user is currently in the middle of a meeting, the electronic device can select a pre-composed message that communicates to the sender that the user is in a meeting.

In another example, the electronic device can determine that the user is currently driving based on the speed of the electronic device (e.g., determined using an accelerometer on the electronic device, determined using a GPS on the electronic device), based on a Bluetooth® or other type of connection with the user's car, etc. The device can then select a pre-composed message that communicates to the sender that the user is currently driving.

At block 710, the electronic device can present the selected pre-composed message to the sender while placing the connection on hold. In some embodiments using session-based communication media, the electronic device can automatically establish a communication session or a connection (e.g., answer a phone call) prior to presenting the selected pre-composed message to the sender. The connection can be put on hold (e.g., hold the call where a connection between the caller and user is established but without connecting the audio input/output such that the caller and user cannot hear each other) while the electronic device presents the selected pre-composed message.

In a sessionless communication, the electronic device need not establish a communication session or a connection prior to presenting the selected pre-composed message to the sender. In some embodiments using sessionless communication media, the electronic device can send the sender a “hold” message (e.g., an email or a text that indicates to hold the communication) before presenting the selected pre-composed message to the sender.

After the pre-composed message is presented or played to the sender, the electronic device can continue to hold the communication until the sender ends the communication session (e.g., hangs up the call). While the communication is put on hold and before the sender ends the communication session, the user can end the hold and start communicating with the sender (e.g., pick up the call and start a live conversation with the caller). If the user ends the hold (e.g., picks up the call) while the message is being presented or played to the sender, the electronic device transitions from presenting or playing the message to allowing the user and the sender to have their conversation.

In some embodiments, the electronic device can select two or more pre-composed messages and combine the selected pre-composed messages into an aggregated message, when the electronic device is determining which pre-composed message to play or present to the sender. To form an aggregated message, the electronic device can select several pre-composed messages and arrange the selected messages in a particular order based on the set of attributes determined at block 706 in FIG. 7. For example, the electronic device can select a pre-composed message that provides information about the user's destination and another pre-composed message the provides information about the user's estimated time of arrival at a target destination and assemble the two messages into an aggregated message to be provided to the sender.

In some embodiments, a pre-composed message can include multiple modular messages where a modular message can be assembled with another modular message on-the-fly into a customized message. For example, a modular message that includes “I will arrive at the meeting” can be combined with another modular message that requires a computation of the estimated time of arrival at the meeting. In some embodiments, the other modular message can be computed in real-time based on the user's current position, velocity, and other information (e.g., traffic information), then combined with the modular message to become a complete customized message presentable to the sender, e.g., “I will arrive at the meeting in about 15 minutes.” Other modular messages can include pre-composed or pre-recorded segments or sub-messages such as a word, a number, a punctuation mark, a sound effect, a visual effect, and/or other basic linguistic components. Enabling the modular message to provide the sender an estimated hold time as described above allows the sender to determine whether she should stay connected (e.g., stay on the phone line) or disconnect (e.g., hang up).

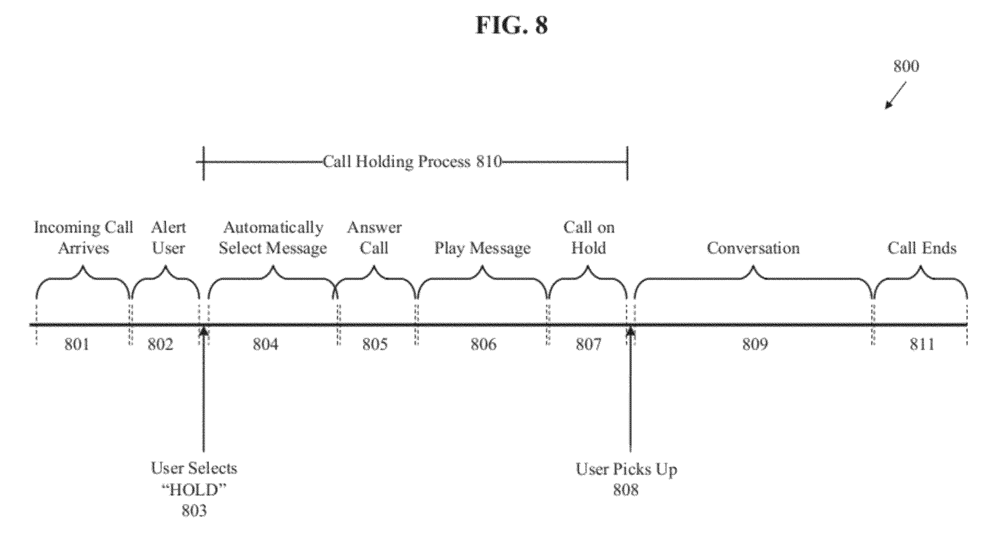

FIG. 8 illustrates an example timeline 800 for operating an electronic device such as a portable communication device (e.g., receiving phone 100) and automatically selecting a pre-recorded message in accordance with some embodiments for a session-based communication. Referring to FIG. 8, operation can begin when the portable communication device receives a signal (801) from a communication network representing a communication request (e.g., the arrival of an incoming call). Upon receiving the signal, the portable communication device can alert the user to the communication request (802) (e.g., the incoming call).

As previously mentioned, the alert can be in the form of an actuator vibrating the housing of the portable communication device if the portable communication device has been set to a vibration mode. Alternatively, the alert can be in the form of ring tones, an onscreen information display (e.g., a caller ID message), flashing backlight of display screen 112, or other audio or visual indications. In the meantime or simultaneously, the portable communication device can also present the user with a number of options to respond to the communication request: accept the communication request (e.g., pick up the call), hold the communication request (e.g., hold the call), decline the communication request (e.g., decline the call), or re-direct the communication request to an automated message system (e.g., re-direct the call to a voicemail system).

If the user accepts the communication request, a communication link (also referred to as “a communication session”) is established between the user and the caller for the two parties to begin communication. If the user selects to re-direct the communication request to an automated message system (e.g., a voicemail system), the communication request can be picked up by the automated message system, which can record a message from the caller. As mentioned, once the communication request is re-directed to the automated message system, the user typically cannot stop the call redirection process to accept the communication request or pick up the call and speak live with the caller. After the caller finishes leaving the message (and hangs up the originating phone), the user can retrieve the message of the caller from the automated message system and/or try to contact the caller (e.g., return a call to the caller). If the user selects to decline the communication request, the communication request can instantly end without allowing the caller to leave a message or wait on the line.

If the user indicates to hold the communication (803) (e.g., hold the call), a communication holding process (810) can start. In response to the user's indication to hold the communication, the portable communication device can automatically determine a pre-recorded message (804) from several pre-recorded messages based on a set of attributes of the user, the portable communication device, and/or the caller. After determining the pre-recorded message to play to the caller, the portable communication device can establish a connection (805) (e.g., answer the incoming call) and present the selected pre-recorded message to the caller (806) (e.g., play back the selected pre-recorded message to the caller). In one example, the pre-recorded message can indicate that the user is temporarily unavailable to join a communication session, and request the caller to stay on the line for a short period of time. After the pre-recorded message is presented to the caller, the portable communication device can continue to hold the communication (807) (e.g., hold the incoming call) until the user can join the communication session (808) (e.g., picks up the call) for the two parties to begin communication.

The user can establish a communication session by pressing a communicate button or a call pickup button (808) (e.g., a physical button or a virtual button) on the portable communication device. Once the user establishes a communication session, the communication holding process 810 ends. The two parties are then “live” and can start communicating (809) until one or both of the parties end the communication session (811). Alternatively, communication holding process 810 can end when one of the two parties decides to no longer stay on hold and terminates the connection.

In some embodiments, the portable communication device can automatically determine to hold the communication instead of waiting for the user to indicate to hold the communication. As described, the portable communication device can determine that the user is currently unable to answer the communication request based on a set of attributes. In one example, the portable communication device can determine that the user is currently in a meeting and unable to answer a call by retrieving the user's schedule from the user's business calendar and/or by analyzing the user's network connection (e.g., the user is connected to particular network connection for a conference room). In another example, the portable communication device can determine that the user is at the gym by retrieving information from the user's personal calendar, by analyzing the portable communication device's physical proximity to another portable communication device identified as the personal trainer's phone, by determining that the portable communication device is connected to workout equipment, and/or by determining that the portable communication device is recording workout data.

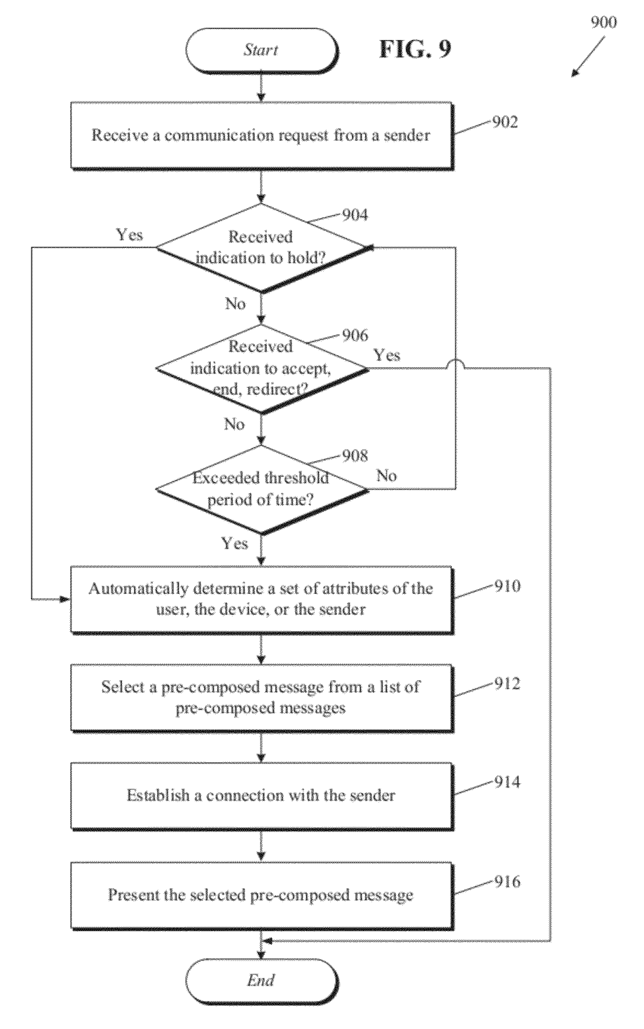

As described, some embodiments can automatically determine the pre-recorded message to be played after receiving a user indication to hold the communication. A portable communication device in some embodiments can automatically perform the determination after not receiving any user input within a time interval after receiving a communication request. FIG. 9 is a flow diagram of a process 900 for allowing a portable communication device (e.g., phone 100 of FIG. 1) to automatically select a pre-recorded message after not receiving a user indication within a certain time period after receiving a communication request according to an embodiment of the present invention.

At block 902, the portable communication device can receive a communication request from a caller. At block 904, the portable communication device can determine whether a user indication to establish a connection (e.g., when user selects to answer the call) and hold the communication (e.g., put the caller on hold) has been received. In some embodiments, a user indication to established a connection and hold the communication can be received upon user selection of a “hold” button, as described above. In some instances, the user indication to hold the communication can further include an indication that the user wants the portable communication device to automatically select a particular pre-recorded message based on a set of attributes.

If a user indication to establish a connection and hold the communication has not been received, at block 906, the portable communication device can determine whether a user indication to accept the communication request, decline the communication request, or redirect the communication request has been received. If a user indication to accept the communication request, decline the communication request, or redirect the communication request has been received, process 900 ends, and the request is handled in accordance with the user indication. If a user indication to accept the communication request, decline the communication request, or redirect the communication request has not been received, at block 908, the portable communication device can determine whether a time interval or a threshold period of time has been exceeded since the communication request was received at block 902.

In some embodiments, the threshold period of time can be configurable by the user or preconfigured by the manufacturer. It can be 5 seconds, 10 seconds, 20 seconds, any other time or a set number of phone rings based on the amount of time the user would like in which to provide a user indication or a selection of a pre-recorded message before the portable communication device proceeds to determine a pre-recorded message without human intervention. Some embodiments can adjust the threshold period of time based on factors such as caller attributes. For example, a predetermined period of time T1 can be used for a first caller and a predetermined period of time T2 can be applied to a second caller. If the threshold period of time has not been exceeded, the portable communication device returns to block 904 and continues to determine whether a user indication (to hold the communication) has been received.

If a user indication to hold the communication has been received within the threshold period of time or if the threshold period of time has been exceeded, at block 910, the portable communication device can automatically determine a set of attributes to be used in selecting appropriate pre-recorded message for the context surrounding this communication request. In some embodiments, the set of attributes can include the user's current situation, the caller's characteristics, characteristics about the user's portable communication device, etc. The user's current situation can include a location, activity, status or availability of the user. Characteristics about the user's portable communication device can include a current speed or velocity, a network to which the portable communication device is connected, the set of applications currently running on the portable communication device, the distance between the portable communication device and another electronic device, etc.

At block 912, the portable communication device can select a pre-composed message (e.g., a pre-recorded message) based at least in part on the set of attributes determined at block 910. Based on the set of attributes, the portable communication device can determine a pre-recorded message that is appropriate to play to the caller in the current situation. For example, the portable communication device can determine that the user is currently asleep (e.g., through pupil detection methods, through the user's schedule, through detecting the current hour and the “silent” setting at which the portable communication device is set) and select a pre-recorded message that indicates that the user is currently asleep and will be able to contact the caller when the user is awake. In some embodiments, the portable communication device can select a particular pre-recorded message from a number of pre-recorded messages that are accessible locally (e.g., stored in the memory of the portable communication device) and/or remotely (e.g., stored at a remote server).

At block 914, the portable communication device can establish a connection with the caller. In this example, a connection or a communication session is established in the session-based communication. However, in a sessionless communication, a communication session need not be established and process 900 can skip block 914. At block 916, the portable communication device can present the pre-composed or pre-recorded message to the caller.

Further, in some embodiments, the portable communication device can retrieve information from other electronic devices (e.g., phones of friends, coworkers' laptops) to more accurately determine the appropriate message to send to the caller. In some instances, the user can be engaging in a similar activity as the people within a certain distance. Therefore, by determining the activity in which other persons in the user's surrounding are engaging, the portable communication device can use this information to more accurately determine the appropriate message. For example, a coworker who had input event information into her calendars or indicated event information through a Web service (e.g., Twitter®, Facebook®, Foursquare®) can be at a same volunteer event as the user. Upon recognizing the device of the coworker, the portable communication device can access and use this additional contextual information to perform a more accurate determination of the user's circumstances. A variety of sources and types of information can be used.

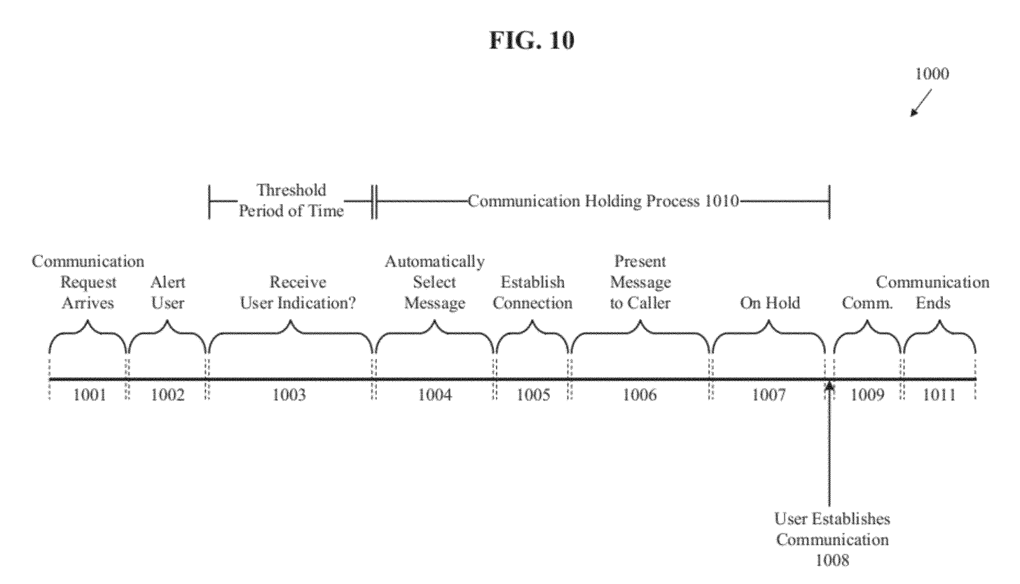

FIG. 10 illustrates an example timeline 1000 for operating a portable communication device (e.g., receiving phone 100) and automatically selecting a pre-recorded message in response to not receiving any user input for a session-based communication. Some embodiments automatically make the selection within a time interval from receiving a communication request from a sender (also referred to as caller) in accordance with some embodiments.

Referring to FIG. 10, operation can begin when the portable communication device 100 receives a signal (1001) from a communication network representing a communication request from another person (e.g., the arrival of an incoming call). Upon receiving the signal, the portable communication device can alert the user to the communication request (1002) (e.g., the incoming call). In the meantime or simultaneously, the portable communication device can present the user with a number of options to respond to the communication request: accept the communication request (e.g., pick up the call), hold the communication request (e.g., hold the call), decline the communication request (e.g., decline the call), or re-direct the communication request to an automated message system (e.g., re-direct the call to a voicemail system).

The portable communication device can determine whether a user indication has been received within a threshold period of time after receiving the communication request (1003). If no user indication is received within a threshold period of time, a communication holding process (1010) starts. In some embodiments, if the user does not accept the communication request, indicate to hold the communication, decline the communication request, or re-direct the communication request to an automated message system within a threshold period of time after receiving the communication request, the portable communication device can enter an automatic message-determination mode and select a pre-recorded message. In response to the lack of user indication during the period of time (1003), the portable communication device can automatically determine a set of attributes in order to determine an appropriate pre-recorded message to present to the caller (1004).

As described above, the set of attributes can include a current location of the portable communication device, a current time, a motion of the portable communication device, a proximity of the portable communication device to one or more other electronic devices, a network connection status of the portable communication device, an application currently running on the portable communication device, a current state of the user, a relationship of the other person to the user, etc. In some embodiments, the set of attributes can also include the product number, the model number, and/or the technical specification of the caller's phone. As such, when selecting a pre-recorded message, the portable communication device can analyze the set of attributes to confirm that the selected pre-recorded message is compatible with the caller's portable communication device such that the caller's portable communication device is capable of playing the selected pre-recorded message.

Alternatively, if the user indicates at some point within the threshold period of time (1003) to hold the communication, the portable communication device can automatically determine the pre-recorded message upon receiving the user indication to hold. In some embodiments, in response to determining the pre-recorded message, the portable communication device can establish a connection with the caller (1005) and then play the selected pre-recorded message to the caller (1006). As described, the pre-recorded message can convey that the user is temporarily unavailable for communication, and ask the caller to stay on hold for some time.

After the pre-recorded message is played, the portable communication device can continue to hold the communication (1007) until the user can join the communication session (1008). Once the user joins the communication session, communication holding process 1010 ends. The two parties are then “live” and so can start communication until one or both of the parties end the communication (1011). Alternatively, communication holding process 1010 can end when one of the two parties decides to no longer stay on hold and terminate the connection.

As described, some embodiments can automatically determine the set of attributes upon receiving, within the threshold period of time after receiving the communication request, the user indication to hold the communication. Some embodiments, however, do not determine the set of attributes until the threshold period of time has passed. Further, the portable communication device in some embodiments can calculate the threshold period of time by analyzing various information including the user's calendar, the user's contacts list, etc. For example, the user's contacts list can include group category and/or priority level information for each contact. If the user's calendar indicates that the user is currently attending an important meeting and that the priority level of the caller is relatively low (e.g., an identified telemarketer), the portable communication device can automatically adjust the threshold period of time to be short (e.g., 2 seconds, 5 seconds). If, however, the user's calendar indicates that the user is currently on lunch break and that the priority level of the caller is relatively high (e.g., Chief Financial Officer of the user's company, family member), the portable communication device can automatically adjust the threshold period of time to be relatively long (e.g., 20 seconds, 30 seconds), giving the user additional opportunity to answer or more time to select the appropriate pre-recorded message to send the caller.

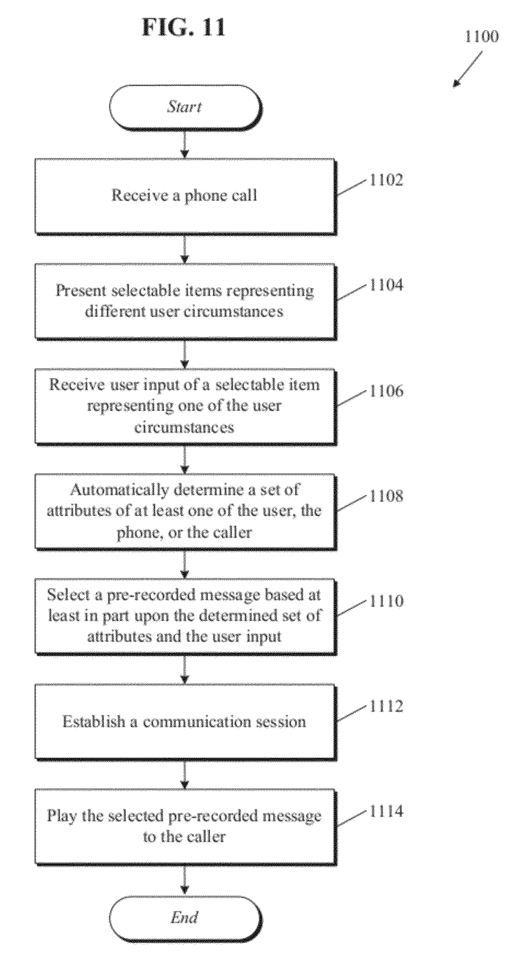

While some embodiments allow the portable communication device to automatically determine the pre-recorded message to send to the caller, some embodiments permit the portable communication device to take user input into account in performing the determination. FIG. 11 is a flow diagram of a process 1100 for allowing the portable communication device to take user input into account in determining the pre-recorded message to present to the caller. At block 1102, the portable communication device receives a communication request from a caller. Similar to some embodiments as described above, a list of options can be presented the user, allowing the user to select to accept the communication request, to hold the communication request, decline the communication request, and/or re-direct the communication request to an automated message system.

At block 1104, the portable communication device presents, for a period of time after receiving the communication request, a set of selectable UI items on the portable communication device representing a set of user circumstances. In some embodiments, the portable communication device can monitor the amount of time that has elapsed after receiving the communication request to determine when the portable communication device should enter automatic message-determination mode. In the meantime (i.e., from the time that the communication request is received to the time after the period of time), the portable communication device can receive user input (e.g., through selection of UI items representing user circumstances) that can be taken into account when the portable communication device is determining the appropriate pre-recorded message for the caller. In some embodiments, the list of options (e.g., accept, hold, decline, re-direct, etc.) can be displayed simultaneously along with the set of selectable UI items. The length of the period of time can be configurable by a user or can be preconfigured by a manufacturer to a default setting. The period of time can be e.g., 5 seconds, 10 seconds, 20 seconds, etc.

At block 1106, the portable communication device receives a user selection of a selectable UI item representing one of the user circumstances. For example, the user can indicate, by selecting a UI item corresponding to a particular circumstance that the user is in the middle of a meeting, that the user is currently busy, or that the user is currently in the restroom, etc. By requesting the user to provide user input (i.e., information about the user's current situation), the portable communication device in some embodiments can use the additional contextual information in selecting the appropriate pre-recorded message. This prevents the user from having to sift through numerous pre-recorded messages to select the appropriate message that the user would like to send to the caller. Otherwise, the portable communication device can receive user input indicating information that would be helpful towards determining the appropriate pre-recorded message (e.g., the period of time after receiving the communication request).

At block 1108, the portable communication device can automatically determine a set of attributes of at least one of the user, the phone, or the caller. While the portable communication device in some embodiments can determine the set of attributes upon reaching a period of time after receiving the communication request, some embodiments determine the set of attributes before reaching the period of time. In some embodiments, the portable communication device can directly enter automated message-determination mode and determine a set of attributes in response to receiving user input indicating that the user would like to hold the communication and/or would like the portable communication device to perform the message determination.

In some embodiments, the set of circumstances can include the user's circumstances, such as the user's location, the user's status, etc. The status of the user can include the availability of the user, an activity in which the user is currently engaged, etc. The portable communication device can determine which pre-recorded message to play to the caller by assessing the set of circumstances and selecting a most appropriate pre-recorded message accordingly.

As previously mentioned, the set of attributes can include a current location of the portable communication device, a current time, a motion of the portable communication device, a proximity of the portable communication device to one or more other portable communication devices, a network connection status of portable communication device, an application currently running on the portable communication device, a current state of the user, a contacts category into which the caller falls, etc. The portable communication device in some embodiments can automatically determine the user's situation including a location, status or availability of the user based on the user's schedule, calendar, or other information stored on or accessible to the portable communication device.

At block 1110, the portable communication device can select the pre-recorded message from several pre-recorded messages based at least in part on the user input received at block 1106 and the set of attributes determined at block 1108. For example, if the portable communication device receives user input indicating that the user is currently engaging in a particular activity (e.g., watching a movie) and obtains access to a set of attributes indicating that the caller is the user's supervisor, the portable communication device can automatically select a generic reply voice message, such as “I am currently unavailable to take your call.” In another example, if the set of attributes indicates that the caller is the user's friend, the portable communication device can select a more detailed message, such as “I am watching a movie and will be able to take calls after 3:30 pm.” Hence, by analyzing user input as well as other available information (i.e., a set of attributes), the portable communication device can intelligently select an appropriate pre-recorded message to play to the caller.

Further, in some embodiments, if the user provides user input (e.g., indicating the user's current activity, indicating the user's circumstances), the user input can be assigned a greater weight than the set of attributes automatically determined by the portable communication device when the portable communication device performs the message selection.

In some embodiments, the portable communication device can present the automatically selected pre-recorded message to the user to allow the user to confirm that the selected message is the message that the user would like to send to the caller. The user can confirm the selected message, manually select another pre-recorded message, or cause the portable communication device to perform another automatic determination while inputting additional information that would enable the portable communication device to perform a more accurate determination. At block 1112, the portable communication device can establish a communication session or a connection with the caller by e.g., answering the phone call. As described above, in a sessionless communication, a communication session need not be established before a pre-composed message may be presented to the sender. At block 1114, the portable communication device can play the selected pre-recorded message to the caller.

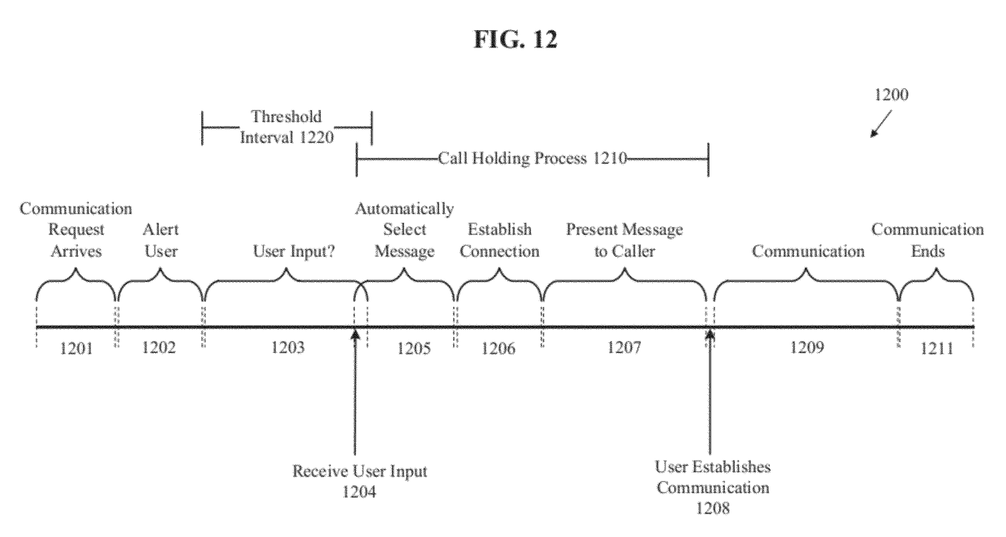

FIG. 12 illustrates an example timeline 1200 for operating a portable communication device (e.g., receiving phone 100) for selecting a pre-recorded message by considering a set of attributes in addition to user input in accordance with some embodiments for session-based communication. Referring to FIG. 12, operation can begin when the receiving portable communication device receives a signal (1201) from a communication network representing a communication request from another user (e.g., the arrival of an incoming call). Upon receiving the signal, the portable communication device can alert the user of the communication request (1202). In the meantime or simultaneously, the portable communication device can present the user with a number of options to respond to the communication request: accept the communication request (e.g., pick up the call), hold the communication request (e.g., hold the call), decline the communication request (e.g., decline the call), or re-direct the communication request to an automated message system (e.g., re-direct the call to a voicemail system).

The portable communication device can determine whether a user input has been received within a time interval or a threshold period of time after receiving the communication request (1203). In some embodiments, user input can provide information on the user's circumstances, such as a location or a status of the user. The status of the user can include the availability of the user, the current activity of the user, etc. In some embodiments, the user input can be received by receiving a user selection of a selectable UI item that corresponds to a command or a piece of information that might indicate the user's circumstances. For example, the user can select a UI item representing the user's current location, such as being at home, which the portable communication device can use for determining an appropriate pre-recorded message.

In some embodiments, if no user input has been received after the threshold interval (1220) has lapsed, the portable communication device can automatically determine the pre-recorded message based on a set of attributes.

If user input indicating to hold the communication or providing information about the user's circumstances is received (1204), a communication holding process (1210) starts. In some embodiments, in response to receiving the user input, the portable communication device can automatically determine a pre-recorded message (1205) based on the user input and a set of user attributes of the user, the phone, and/or the caller. As described above, the set of attributes can include a current location of the portable communication device, remaining battery power of the portable communication device, a current time, a motion of the portable communication device, a proximity of the portable communication device to one or more other portable communication devices, a network connection status of the portable communication device, a current state of the user, a category of the caller, etc. Alternatively, the user can select the pre-recorded message to play to the caller.

In some embodiments, the portable communication device can establish a connection (1206) and present the selected pre-recorded message to the caller (1207). The pre-recorded message can indicate that the user is temporarily unavailable for communication, and request the caller to stay connected for a short time. In some embodiments, after the pre-recorded message is presented, the portable communication device can continue to hold the communication until the user establishes the communication session (1208). The user can also establish the communication session as the message finishes playing. Once the user establishes the communication session, the communication holding process 1210 ends. The two parties are then “live” and so can freely communicate (1209) until one or both of the parties terminates the communication (1211). Alternatively, the communication holding process 1210 can end when one of the two parties decides to no longer stay on hold and terminates the connection.

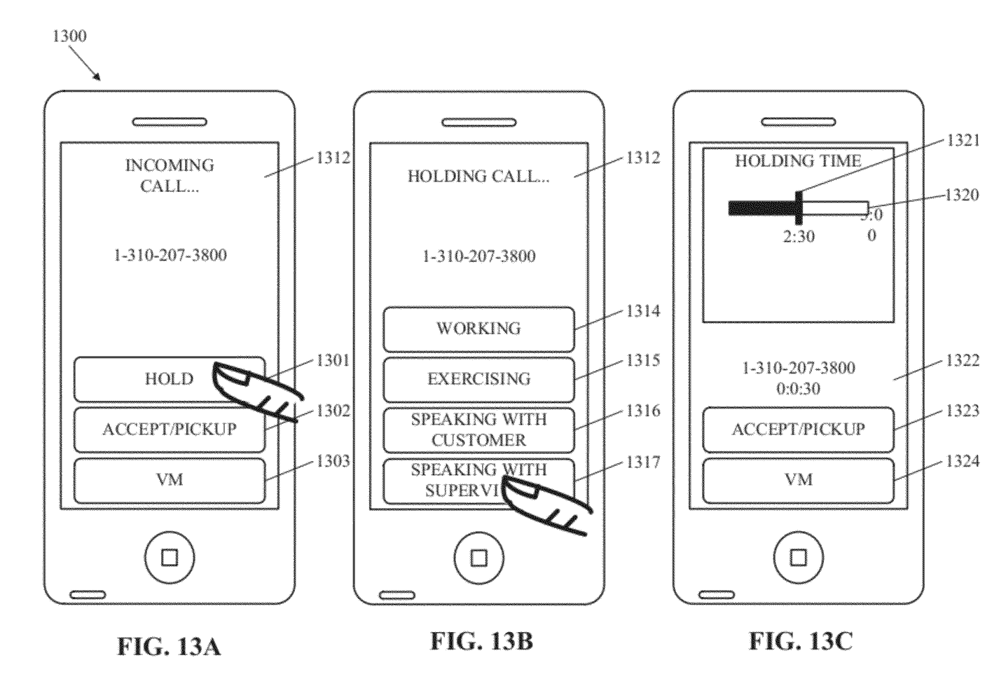

FIGS. 13A-13C illustrate an example sequence of screen images for portable communication device 1300 (similar or identical to receiving phone 100) that automatically determines a pre-recorded message in accordance with some embodiments. As shown in FIG. 13A, in response to the arrival of a communication request signal, portable communication device 1300 displays “INCOMING CALL . . . ” on a display screen 1312 (similar or identical to display screen 112) and an identifier (e.g., a name, a number) assigned to the caller sending the communication request. In some embodiments, display screen 1312 can present a number of options for the user to select, including: hold 1301 (similar or identical to hold 401), accept 1302 (similar or identical to accept 402) and re-direct 1303 (similar or identical to re-direct 403). The user can select one of these options using a physical button or a virtual button.

As shown, once the user selects hold option 1301 in FIG. 13A, display screen 1312 in FIG. 13B can show “HOLDING CALL . . . ” to indicate that the communication holding process has started. Display screen 1312 can also show the calling number and/or the nickname of the caller. In one embodiment shown in FIG. 13B, portable communication device 1300 can provide the user with a number of additional options, each being some type of user input (e.g., selection of a UI item that indicates a user circumstance) that would enable portable communication device 1300 to make a determination as to which pre-recorded message would be the appropriate message to play to the caller.

For example, option 1314 can represent a user circumstance indicating a situation or circumstance of the user (e.g., that the user is currently working). Similarly, selection of options 1315-1317 can indicate that the user is exercising, speaking with a customer, or speaking with a supervisor. If the user selects one of options 1314-1317 (in some instances, indicating that the user would like portable communication device 1300 to make the determination for which message to send to the caller), portable communication device 1300 can automatically determine a pre-recorded message using a set of user attributes and the user input indicating the user's current circumstances (i.e., speaking with supervisor).

In an alternative embodiment, portable communication device 1300 can display options 1314-1317 at the same time (i.e., on the same screen image) as the initial hold/pickup/voicemail options 1301-1303. In another embodiment, portable communication device 1300 can be configured to associate a particular default message with a caller based on the phone number or the caller identifier of the caller. Thus, when the caller sends a communication request to portable communication device 1300 and is placed on hold, the default message associated with the caller can be an option presented to the user for selection to play to the caller.

Further, in some embodiments, the list of options 1314-1317 can include a customizable set of options tailored to the user's current situation. Portable communication device 1300 can determine the user's current situation, activity, location, etc. (e.g., using the user's calendar) and present a list of options that would likely be suitable for the user's current situation. For example, if the portable communication device determined that the user is in a meeting, the portable communication device can present the user with a list of options different from a list of options that the portable communication device can present the user when the portable communication device determines that the user is at dinner.

In yet another embodiment, before the user is engaged in a situation in which he will be temporarily be unavailable for communication with others during a particular time interval (e.g., scheduled to be at a meeting from 3-5 PM), the user can select a pre-select a pre-recorded message indicating that she will be in a meeting for the particular time interval. Then once the user selects hold option 1301, a pre-recorded message indicating that the user is in a meeting will be automatically played without further requiring the user to indicate that she is working via selecting option 1314.

Once the user indicates to hold the communication, portable communication device 1300 plays back a default or a selected message to the caller while holding the communication. The message sent to the caller can incorporate an estimated length of hold time as indicated by the user. Referring to FIG. 13C, the user can enter an estimated hold time with an estimated hold time indicator 1320 (similar or identical to estimated hold time indicator 420) provided on display screen 1312. In some embodiments, portable communication device 1300 can automatically determine an estimated hold time using information about the user's schedule that is accessible by the portable communication device. For example, the portable communication device can obtain access to the user's calendar information (e.g., on the Web, stored locally) and calculate the remaining amount of time until the user becomes available.

As mentioned, the estimated hold time indicator 1320 can be a slide bar that indicates the estimated hold time. In some embodiments, the slide bar can be adjusted by the user. Some embodiments allow portable communication device 1300 to perform a hold time estimate, which can be indicated through estimated hold time indicator 1320. The user can then readjust the estimated hold time if needed. The entire length of the slide bar may represent a maximum hold time (e.g., 5 minutes), which can be configured by the user. The slide bar may be adjusted by a configurable increment (e.g., 10 seconds).

In the embodiment of FIG. 13C, the user can move an adjustment tab 1321 (similar or identical to adjustment tab 421) along the slide bar to indicate an estimated hold time in the increment of 10 seconds up to a maximum of 5 minutes. Portable communication device 1300 can detect the position of the adjustment tab 1321, convert the position into a length of time, and incorporate the length of time into the pre-recorded message played to the caller. For example, the user can pre-record a message to say “I am in a meeting right now, but please hold and I will answer your call shortly.” Portable communication device 1300 can automatically insert the estimated hold time into the message, e.g., at the end of the message, to say “The estimated hold time is 2 minutes.” The feature of the estimated hold time can be activated and/or deactivated by the user any time before or during the receipt of a communication request.

In some embodiments, portable communication device 1300 can automatically determine the estimated hold time by comparing the current time with the user's schedule, which, may be e.g., stored in the user's calendar or indicated in the user's alarm system). For example, if the user's calendar indicates that the user's meeting is set to end at a particular time (e.g., 3 PM), the caller can be informed that the user is currently in a meeting and that the user will become available after the user's scheduled meeting. In another example, if the user's alarm is set at 7 AM, portable communication device 1300 can inform the caller that the user is currently asleep and that the user will become available for communication after 7 AM, or after a period of time, determined by comparing the current time and the time that the alarm is set to go off.

The display screen 1312 can show an elapsed time indicator 1322 (similar or identical to elapsed time indicator 422) that indicates how long the caller has been placed on hold. At any time during the hold, the user can pick up the call (using option 1323 (similar or identical to option 423)) or re-direct the call to voicemail (using option 1324 (similar or identical to option 424)). If option 1324 is selected, a special voicemail greeting can be played to the caller to indicate that the user cannot pick up the call within a reasonable amount of wait time as she has previously expected. For example, the special voicemail greeting may indicate: “Sorry for the wait, but I cannot pick up your call at this time. Please leave a message after the tone.”

In one embodiment, the estimated hold time can be updated by the user while the communication request is placed on hold. For example, after the communication is on hold for 30 seconds, the user may realize that more or less hold time is needed. The user can change the hold time by moving adjustment tab 1321 on the slide bar to the right (e.g., more hold time) or to the left (e.g., less hold time). In response to the change of the hold time, portable communication device 1300 can automatically announce to the caller the updated hold time estimate.

In some scenarios, the communication request may arrive when the user is on another line of portable communication device 1300. Conventional devices provide a call waiting feature which allows the user to suspend the call in progress and switch to the incoming communication request.

Instead of or in additional to the call waiting feature, portable communication device 1300 can continue the in-progress communication without interruption, while holding the incoming communication for the user. While holding the incoming communication, portable communication device 1300 can automatically play back a pre-recorded message to ask the caller to remain on hold until the user is available for communication. This message can state that the user is on another call.

In general, the portable communication device (e.g., the telephone module 238) may be configured or programmed by the user to support one or more of the above-described phone hold features. To conclude, various ways of holding an incoming telephone call in a portable communication device (e.g., a mobile phone) have been described. These techniques render a more user-friendly phone hold process for the user of a receiving phone. As explained above, an embodiment of the invention may be a machine-readable medium (such as memory 240) having stored thereon instructions which program a processor to perform some of the operations described above. In other embodiments, some of these operations might be performed by specific hardware components that contain hardwired logic. Those operations might alternatively be performed by any combination of programmed data processing components and custom hardware components.

While the invention has been described with respect to specific embodiments, one skilled in the art will recognize that numerous modifications are possible. While several of the examples presented above are described with respect to a particular type of communication (i.e., phone call), various other types of communication are applicable to the present invention as well. For example, some embodiments can automatically determine and present pre-composed messages to a sender when the recipient is unable to respond to a communication for other session-based communication including video chat, IM communication, etc. as well as sessionless communication including emails, SMS, etc. Furthermore, while several of the examples presented above are described with respect to a portable communication device, various types of electronic devices (e.g., tablet computer, a mobile telephone, a smart phone, a desktop computer, a laptop computer, a kiosk, etc.) can be used by the recipient and the sender for the various embodiments described above. Thus, although the invention has been described with respect to specific embodiments, it will be appreciated that the invention is intended to cover all modifications and equivalents within the scope of the following claims.

What is claimed is:

1. A method, comprising:
receiving, at an electronic device of a first user, a communication request from an electronic device of a second user;
generating, by the device of the first user, an alert that the communication request is being received;
determining, by the device of the first user, whether a user indication regarding establishing a connection between the device of the first user and the device of the second user in response to the communication request is received within a predetermined period of time after generating the alert;
if the user indication is received within the predetermined period of time, responding to the communication request in accordance with the user indication; and
if the user indication is not received within the predetermined period of time:
determining, by the device of the first user, a set of attributes of at least one of the first user, the portable communication device of the first user, or the second user;
selecting, by the device of the first user, based at least in part on the determined set of attributes, a pre-composed message from a plurality of pre-composed messages; and
providing, by the device of the first user, the selected pre-composed message to the second user.

2. The method of claim 1, wherein responding to the communication request in accordance with the user indication when the user indication is received within the predetermined period of time includes:
determining whether the user indication includes either an instruction to respond to the communication request by providing a particular pre-composed message or an instruction to allow the portable communication device to automatically select the pre-composed message based on the set of attributes; and
if the user indication includes the instruction to respond to the communication request, providing the particular pre-composed message to the second user.

3. The method of claim 2, further comprising, after receiving the instruction to respond to the communication request, presenting the first user with a plurality of pre-composed messages, wherein the particular pre-recorded message is determined based upon a user selection of one of the plurality of pre-composed messages.

4. The method of claim 1, further comprising:
after selecting the pre-composed message, receiving a user selection of a different pre-composed message from the selected pre-composed message; and
in response to receiving the user selection of the different pre-composed message, providing the different pre-recorded message to the second user instead of the selected pre-composed message.

5. The method of claim 1, further comprising:
in response to selecting the pre-composed message from the plurality of pre-composed messages, allowing the first user to provide a confirmation of the selected pre-composed message, wherein the selected pre-composed message is provided to the second user only if the first user provides the confirmation.

6. A method, comprising:
receiving, at an electronic device of a first user, a communication request from an electronic device of a second user;
determining, by the device of the first user, that the first user is not responding to the communication request and further determining, by the device of the first user, a set of attributes of at least one of the first user, the device of the first user, or the second user;
selecting, based at least in part on the determined set of attributes, a pre-composed message from a plurality of pre-composed messages; and
providing the selected pre-composed message to the second user.

7. The method of claim 6, wherein providing the selected pre-composed message includes establishing a connection between the device of the first user and the device of the second user in response to the communication request.

8. The method of claim 6, wherein the set of attributes includes at least one of a current location of the device of the first user, a current time, a motion of the device of the first user, a proximity of the device of the first user to one or more other electronic devices, a network connection status of the device of the first user, an application currently running on the device of the first user, or a current state of the first user.

9. The method of claim 6, wherein determining that the first user is not responding to the communication request includes receiving an indication from the first user that the first user is unavailable for communication with the second user.

10. The method of claim 9, wherein the indication includes at least one of a selection of an icon, a voice command, a gesture, or an operation of a physical control device on the device of the first user.

11. The method of claim 6, further comprising:
in response to a particular user indication, transitioning from providing the selected pre-composed message to a live conversation between the first user and the second user.

12. A method of automatically responding to a phone call by a phone, the method comprising:
receiving a phone call from a caller;
for a predetermined period of time after receiving the phone call, presenting a set of selectable user-interface (UI) items representing a set of user circumstances;
receiving a user selection of one of the selectable UI items;
determining a set of attributes of at least one of the user, the phone, or the caller;
based at least in part on the determined set of attributes and the selected UI item, selecting a pre-recorded message from a plurality of pre-recorded messages; and
answering the phone call and playing the selected pre-recorded message to the caller.

13. The method of claim 12, wherein the set of attributes includes at least one of a location of the phone, an availability status of the user, a speed of motion of the phone, or a distance between the phone and another electronic device.

14. The method of claim 12, wherein during the selecting of the pre-recorded message from the plurality of pre-recorded messages, the selected UI item is assigned a weight greater than a weight assigned to the determined set of attributes.

15. The method of claim 12, wherein the set of attributes includes a schedule of the user based, at least in part, on an electronic calendar of the user, the method further comprising:
determining a current time; and
calculating an amount of time before the user becomes available based on the current time and the schedule of the user, wherein the selected pre-recorded message played to the caller indicates the calculated time.

16. The method of claim 12, wherein the set of selectable UI items includes a plurality of items representing activities in which the user might be engaged.

17. A computer-readable storage medium containing program instructions to be executed in response to receiving a phone call at a phone, wherein the instructions, when executed by one or more processors, cause the one or more processors to execute a method of selecting a pre-recorded message, the method comprising:
monitoring, at the phone, an amount of time that has elapsed since receiving the phone call from the caller;
if the amount of time that has elapsed is less than a predetermined amount of time, determining whether a user indication has been received, the user indication including at least one of accepting the phone call, selecting a pre-recorded message, instructing the phone to select a pre-recorded message, or ignoring the call;
if the amount of time that has elapsed exceeds or equals the predetermined amount of time, automatically selecting a pre-recorded message based on a set of attributes of at least one of the user, the phone, or the caller; and
answering the phone call and playing the selected pre-recorded message to the caller.

18. The computer-readable storage medium of claim 17, wherein the user indication includes at least one of a voice command from the user, a gesture input from the user, a gaze input from the user, or a keyboard input.

19. The computer-readable storage medium of claim 17, wherein the pre-recorded message includes at least one of a video component, a still image component, or an audio component.

20. The computer-readable storage medium of claim 17, wherein the selected pre-recorded message is an aggregated message that includes more than one pre-recorded message.

21. A phone comprising:
a transceiver unit to receive a phone call;
a processor coupled to the transceiver unit;
a memory device coupled to the processor, the memory device including instructions to be executed in response to receiving a phone call at the transceiver unit, wherein the instructions, when executed by the processor, cause the processor to:
monitor the amount of time that has elapsed upon receiving the phone call from the caller;
if the amount of time that has elapsed is less than a predetermined amount of time, determine whether user indication has been received, the user indication including at least one of accepting the phone call, selecting a pre-recorded message, instructing the phone to select a pre-recorded message, or ignoring the call; and
if the user indication is not received during the predetermined amount of time, automatically select a pre-recorded message based on a set of attributes of at least one of the user, the phone, or the caller.

22. The phone of claim 21, wherein a first portion of the pre-recorded message is stored locally in the memory device and a second portion of the pre-recorded message is stored on a remote server.

23. The phone of claim 21, wherein the pre-recorded message is constructed from a plurality of sub-messages, wherein each sub-message is either a word or a number.

24. The phone of claim 21, wherein a copy of the pre-recorded message is stored on a remote server accessible to the phone.
